(19) United States
(12) Patent Application Publication
(10) Pub. No.: US 2024/0355051 A1
(43) Pub. Date: Oct. 24, 2024

(54) DIFFERENTIABLE FACIAL INTERNALS MESHING MODEL

(71) Applicant: InterDigital CE Patent Holdings, SAS, Paris (FR)

(72) Inventors: Junghyun Ahn, New York, NY (US); Louis Chevallier, La Meziere (FR); Abdallah Dib, Cesson-Sevigne (FR); Cedric Thebault, Saint-Aubin-D’Aubigne (FR); Philippe Henri Gosselin, Thorigne-Fouillard (FR)

(21) Appl. No.: 18/285,934

(22) PCT Filed: Apr. 4, 2022
(86) PCT No.: PCT/EP2022/058897

§ 371 Date: Oct. 6, 2023

(30) Foreign Application Priority Data
Apr. 9, 2021 (EP) 21305469.5

(51) Int. Cl. G06T 17/20; G06T 7/90; G06T 13/40

(52) U.S. Cl. CPC G06T 17/20; G06T 7/90; G06T 13/40; G06T 2207/30201

(57) ABSTRACT

A method and apparatus is provided for building a facial model of a three dimensional face from a two dimensional image. The method involves replacing any missing areas by at least one intermediate filler and obtaining a plurality of polynomials for the upper and lower boundaries of any of the replaced intermediate filler areas. The differentiable parameters and coefficients pertaining to the selected intermediate filler areas are then determined and an inversible rendering of the face is provided by modifying any intermediate filler(s) based on the obtained polynomials with details based on said differentiable parameters and coefficients.

### TECHNICAL FIELD

The present disclosure generally relates to 3D facial reconstruction models from a monocular video input and more particularly to differentiable facial internal models such as eye and mouth used for inverse rendering.

### BACKGROUND

Facial reconstruction systems that include facial recognition have seen wide attention in the past few years. A facial recognition system is a technology that is capable of using at least parts of a human face as a recognition biometric. Facial recognition systems are being deployed in a variety of applications such as video surveillance, automatic indexing of images, advance human computer interactions and authenticating users in establishing access to a place or an account to uses that involve crime identification and law enforcement issues. A closely related technology is that of facial reconstruction. The reconstruction technology can be used to enable facial recognition but it can be also used in much broader contexts.

In either case, the development in technology has allowed the facial reconstruction and recognition systems to become more successful. Most consumer devices today can digitally capture an image or video. In this regard, the initial digital technology has grown from a computer only application to include systems that allow smartphones and other forms of technology such as those that incorporate robotics to use it.

Computerized facial recognition involves the measurement of one or more physiological characteristics of a human face as a biometric. Accuracy is important in this regard because poorly captured in passing images or faulty applications may render disastrous results. Unfortunately, prior art does not provide such accuracy in many instances. Even when prior art provides accuracies on one element, such as an individual eye or a mouth, these are done independently of each other. For example, sometimes an eyeball mesh is used in prior art technology. An eyeball mesh in such instances is considered to be a facial internal for an eye and consists of multiple layers and more than half of these mesh surfaces that are not visible inside the eye socket mesh, which in turn is not visible itself. Also, this complex eyeball structure is not easy to adapt to different identity of a person that needs to reconstructed from the image. Therefore, prior art technology that uses complex mesh leads to problematic performance for the consumer electronics. Consequently, techniques need to be presented that simplify recognition task and creates more reliable recognition systems.

### SUMMARY

A method and apparatus for building a facial model is provided. The model in one embodiment is provided from a two dimensional image into a three dimensional model. The method involves replacing any missing areas by at least one intermediate filler and obtaining a plurality of polynomials for the upper and lower boundaries of any of the replaced intermediate filler areas. The differentiable parameters and coefficients pertaining to the selected intermediate filler areas are then determined and an inversible rendering of the face is provided by modifying any intermediate filler(s) based on the obtained polynomials.

### BRIEF DESCRIPTION OF THE DRAWINGS

The teachings of the present disclosure can be readily understood by considering the following detailed description in conjunction with the accompanying drawings, in which:

FIG. 1 is a prior art illustration of 3D facial reconstruction models;

FIG. 2 is an illustration of an overall facial internals meshing framework as per different embodiments;

FIG. 3 is an illustration of a differentiable eye model;

FIG. 4 is an illustration of an eye meshing/painting pipeline and results as per one embodiment;

FIG. 5 is an illustration of a differentiable mouth model;

FIG. 6 is an illustration of a mouth meshing/painting pipeline and results as per one embodiment;

FIG. 7 is an illustration of a trajectory for the autonomous device according to yet another embodiment;

FIG. 7 is an illustration of a workflow according to another embodiment;

FIG. 8 is a schematic illustration of a general overview of an encoding and decoding system according to one or more embodiments; and

FIG. 9 is another flow chart illustration for generating a facial model according to one embodiment.

### DETAILED DESCRIPTION OF PREFERRED EMBODIMENTS

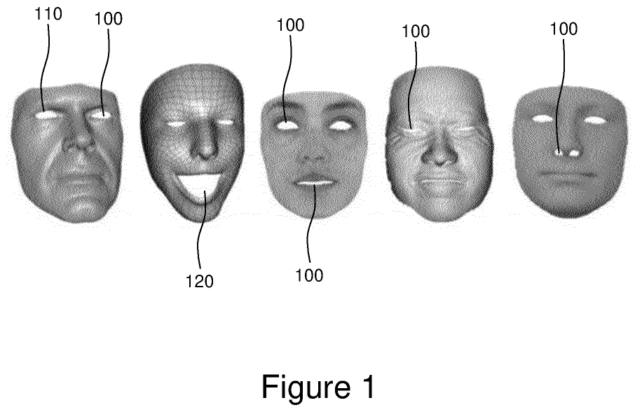

FIG. 1 is an illustration of a 3D facial reconstruction as used in many prior art facial recognition applications. The 3D facial internals of some body parts, such as eyes and mouth are complex, concave, occluded, and boundary elements collide frequently. Due to this complexity, the internal objects of some areas in a 3D facial image are often masked out or cut off for better facial surface reconstruction. These cut out areas are depicted by reference numerals 100 in FIG. 1 and are examples which may be referred to as missing areas. In the example of FIG. 1, this leaves a facial mask without the eyes and mouth, which leads the holes missing the geometric information. Unfortunately, on performing a facial mesh reconstruction, the input image pixels that correspond to the inside of the hole or cutout area 100 include important information such as eye gaze, iris colors, teeth location, dark nasal vestibule and so on that are pertinent in providing accurate recognition and matching.

To address some of the shortcoming of the prior art, on embodiment as will be presently discussed in detail uses these internal features and provides a parametrized hole-filling geometry that could, not only retrieve the information inside the facial holes, but also helps in reconstructing better a 3D facial animation as an additional optimization feature.

The current formulations that are focused on a 3D facial mask are developed for two main reasons. A first reason has to do with the Visual Effects or VFX industry. VFX is a process of creating imagery or manipulating already available imagery in alive action or video production and film production industry. The integration of live action footage and computer generated (CG) elements to create realistic imagery is called VFX. In VFX, the standard 3D shapes of the facial internals are relatively over complexed comparing to the amount of area that is visible from the input images. Referring back to FIG. 1, an eyeball mesh which is supposed to be located in 110 area is considered to be a facial internal for an eye, which consists of multiple layers. Often more than half of these mesh surfaces are not visible inside the eye socket mesh, which in turn is not visible itself. Moreover, the mouth internal 120 view consists of many individual objects such as teeth, and by default it is closed. Even with the mouth opened, the inside often appears dark due to a bad illumination condition and information cannot be obtained in much detail.

In one embodiment, it is also possible to reconstruct 3D facial animation via an autoencoder-based architecture. In the prior art, the loss formulation for this self-supervising network does not consider facial internals. With that in mind, the importance of formulating the facial internals remains high, as this additional information can be crucial on delivering subtle changes around the eyelids and lips, giving a big difference on the global facial expressions and the mood of a person.

The proposed solution addresses some of these prior art shortcomings. In one embodiment, a formulation can be provided that combines an end-to-end optimized network element in facial reconstruction with a variety of components such as an eye gaze and teeth appearance in providing a 3D model for final consideration. This approach has a capability to formulate procedures and algorithms, resulting in a computation graph, able to back-propagate gradients to origin variables. This makes not only gradient decent possible, but also facilitates the design of a variety of different networks as known to those skilled in the art (for example a neural network framework.) The same applies for the 3D facial reconstruction problem from a single image or a video. This improvement is needed on 3D reconstruction especially around certain critical areas such as around the eyes and the mouth area for reasons already delineated. It should also be noted that some areas such as inside of eyelids and lips contours, also facilitate the convergence of the optimization steps because they provide different colors contrasts comparing to the facial skin. In one embodiment, the proposed framework gives an extendibility to combine with blend shapes and audio tracks for better facial reenactment. In this aspect, a novel facial internals meshing framework on the domain of the 3D reconstruction of facial animation from a monocular RGB (Red/Green/Blue) video, especially, applicable on the differentiable eyes and mouth hole filling algorithms that enhance the performance of the optimization without a complex/scanned 3D geometries can be provided in one embodiment.

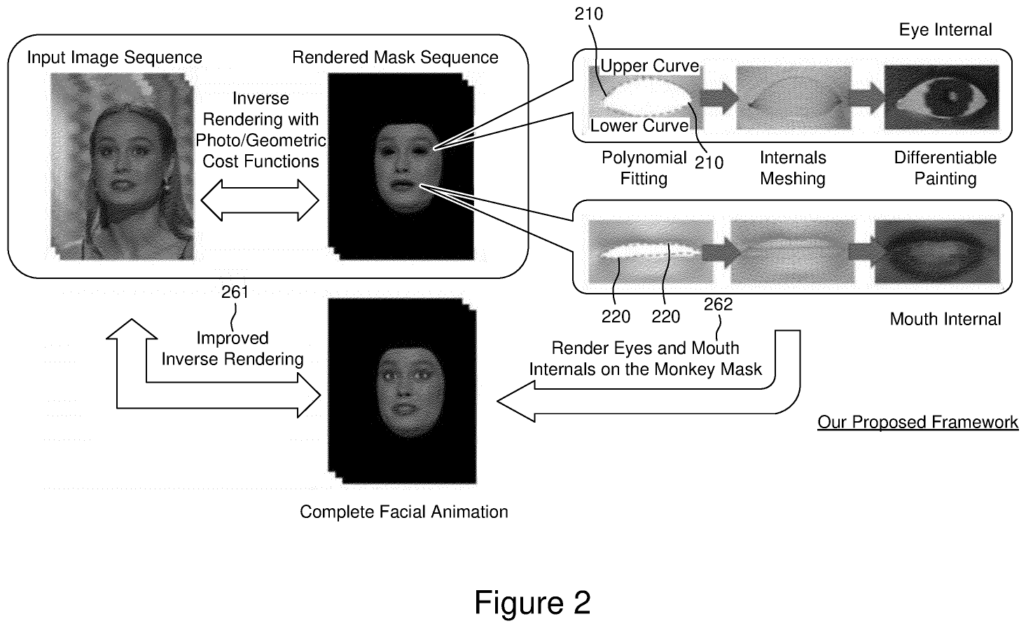

FIG. 2 is an embodiment that depicts an overall facial internal meshing framework. One aspect of this approach fills in the cut off areas by the polynomial curves fitted onto the upper and lower outlines of each hole as respectively referenced by numerals 210 and 220. This differentiable fitting coefficients are used for computing colors on the created model.

In another aspect, meshed and painted models are combined as parts of the entire face and improve the result of the traditional facial animation reconstruction (such as monkey mask 262 or inverse rendering 261), either in gradient-decent-based or in deep-based approaches.

To ease understanding of this approach a Polynomial Fitting model can be discussed. In FIG. 2, the contours of eyes and mouth objects consist of the upper and lower curves. This is true for both elements which are provided in this example, which consist of eyelids 210 and lips 220. However, as can be understood this approach can be used with other elements and body parts or other composite parts of an image.

As described in the equation below, each curve can be approximated to a d-order polynomial equation. The m sample positions v are taken from the contour vertices of the corresponding hole outline. The t parameter ranges between 0 and 1, and the sample parameter values are computed by the accumulated sum of edge lengths calculated from the sequence of outline vertices. The fitting equation includes n animation frames and is possible to solve the entire animation at once in real-time. The polynomial coefficients c is the unknown and must be solved. These fitted coefficients represents the parametrized nonlinear curve of the whole animation sequence.

$$[ \begin{matrix}1 & 0 & 0 & & 0 \\ ⋮ & ⋮ & ⋮ & & ⋮ \\ 1 & t & {t}^{2} & … & {t}^{d} \\ ⋮ & ⋮ & ⋮ & & ⋮ \\ 1 & 1 & 1 & & 1\end{matrix} ] [ \begin{matrix}{c}_{0}^{x 1} & {c}_{0}^{y 1} & {c}_{0}^{z 1} & & {c}_{0}^{xn} & {c}_{0}^{yn} & {c}_{0}^{zn} \\ {c}_{1}^{x 1} & {c}_{1}^{y 1} & {c}_{1}^{z 1} & & {c}_{1}^{xn} & {c}_{1}^{yn} & {c}_{1}^{zn} \\ {c}_{2}^{x 1} & {c}_{2}^{y 1} & {c}_{2}^{z 1} & … & {c}_{2}^{xn} & {c}_{2}^{yn} & {c}_{2}^{zn} \\ & ⋮ & & & & ⋮ & \\ {c}_{d}^{x 1} & {c}_{d}^{y 1} & {c}_{d}^{z 1} & & {c}_{d}^{xn} & {c}_{d}^{yn} & {c}_{d}^{zn}\end{matrix} ] = [ \begin{matrix}{v}_{1}^{x 1} & {v}_{1}^{y 1} & {v}_{1}^{z 1} & & {v}_{1}^{zn} \\ ⋮ & ⋮ & ⋮ & & ⋮ \\ {v}_{i}^{x 1} & {v}_{i}^{y 1} & {v}_{i}^{z 1} & … & {v}_{i}^{z n} \\ ⋮ & ⋮ & ⋮ & & ⋮ \\ {v}_{m}^{x 1} & {v}_{m}^{y 1} & {v}_{m}^{z 1} & & {v}_{m}^{z n}\end{matrix} ]$$

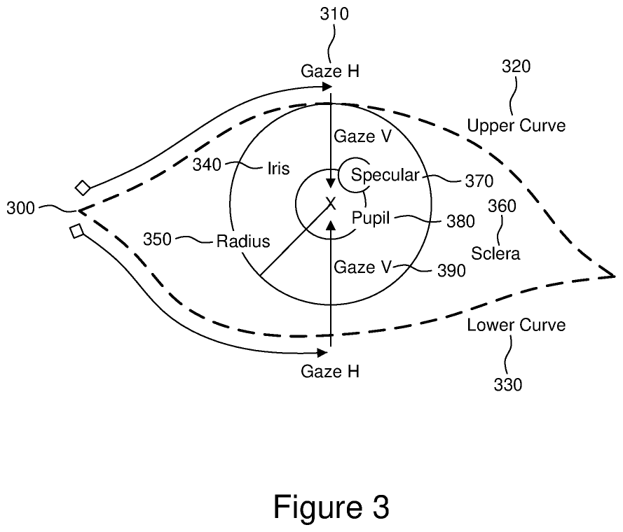

To understand this better, the Internal Meshing for the eyes can be discussed more closely. The eye mesh is created by filling the vertices and triangles between the upper and lower fitted curves. To match with the resolution of the facial mask, the number of curve samples m is applied for the number of vertical lines. The spacing between the vertical line is based on the edge length as the sample intervals. For the horizontal line, an equal space is defined and an odd number chosen to locate the center of the iris on the mid-horizontal line. The result of an eye internal mesh is depicted in FIG. 2 (in the “Eye Internal” block), along with the created eye mesh, shown in FIG. 3. FIG. 3, therefore provides for a differentiable eye model (for painting the eye).

In FIG. 3, the details of the eye parameters are as follows:
1—Gazes (per frame): A gaze parameter consists of Horizontal (H) and Vertical (V) (Gaze H and V depicted by numerals 310 and 390) values ranging from 0 to 1. This 2D vector is defined for each animation frame and the final optimized values can be served as gaze detection coordinates of the given image sequence. The horizontal gaze position is retrieved by the fitted polynomial coefficient and the Gaze H parameters in FIG. 3. Each polynomial has an upper and lower curve 320 and 330 provided from a corner of the eye 300.
2—Radius 350—the radius of the iris is also adjusted by this scalar parameter. The radius of the pupil is also applicable in this model.
3—Pupil 380: this consists of the color of pupil.
4—Iris 340: this includes the color of iris.
5—Sclera 360: this includes the color of sclera. As an additional option element.

Specular (370) can be included: a specular dot is often visible in an eye image. It is possible to locate a dot from the center point computed by the gaze parameter.

The specular parameters are as follows:
Coordinate: Polar coordinate from the center of gaze
Intensity: Grey level intensity
Radius For painting an eye, a tensor of vertex distance is used.

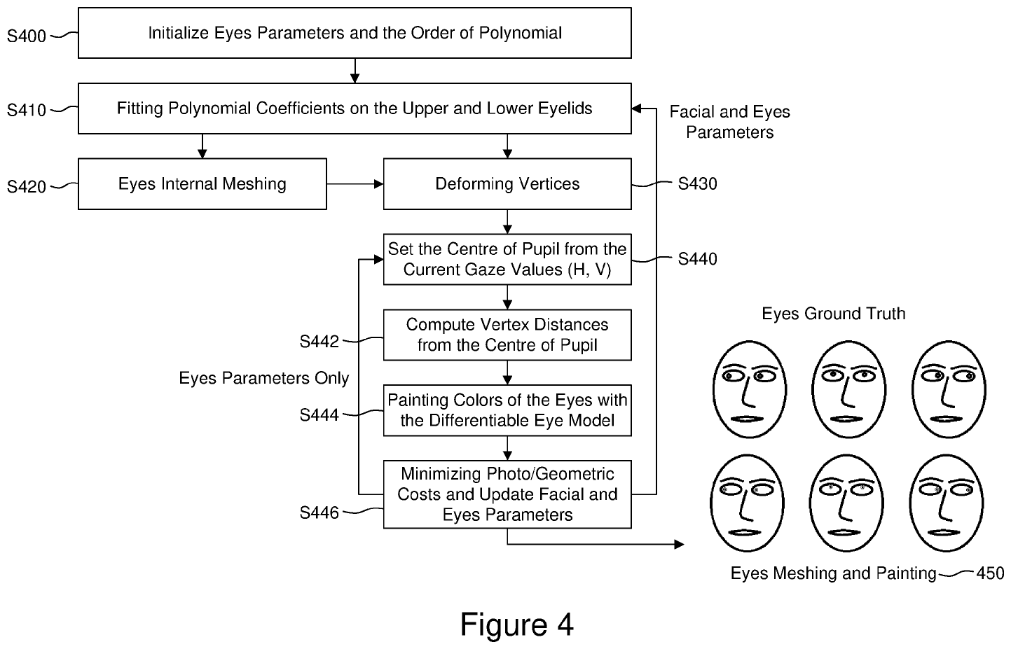

From a per-frame gaze coordinate (H, V), the center position is computed in the eye space. Then the distance to each eye vertex is stored in a tensor. A sigmoid function could smoothly separate the color of eye vertices as shown in FIG. 2 (in the “Eye Internal” block). The detailed eyes painting pipeline and the results are depicted in FIG. 4.

In FIG. 4, in Step 400 or S400, there is a determination that a polynomial calculation is to be determined on the cutout portions for the eye. Eye parameters and the order of polynomial can be initiated. The method includes in S410 of the fitting polynomial coefficients on the upper and lower portions, here the eyelids. Then in S420, the internal meshing of the eyes is performed that includes deforming vertices in S430 and then tending to the determination of eye parameters in S440 to S450 which includes setting of the pupils from the gaze in S440, for example by setting the center of the pupil from the current gaze values (H,V) computing vertex distances in S442, for example by computing vertex distances from the center of pupil, painting colors in S444 for example by painting colors of the eyes with the differentiable eye model and minimizing photo and geometric costs 446. Facial and eye parameters can be updated. This leads to the result as shown at 450.

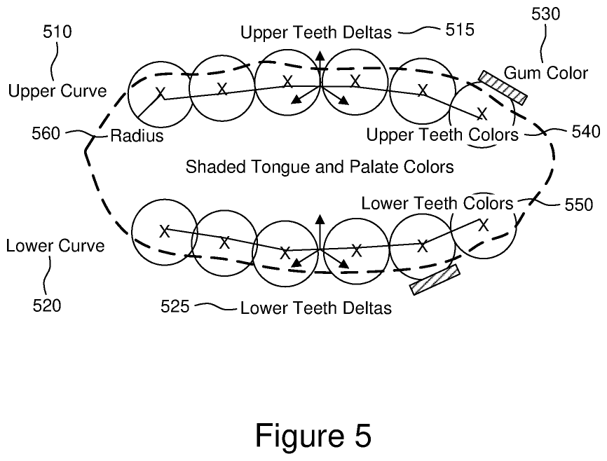

A similar exercise can be provided for the mouth. A Mouth Internal Meshings, however, are unlike that of the eyes in several respect. For one the eyes have a convex shape, but the structure of mouth internal has a concave shape. By default, the internal mouth structures are often hidden, and the internal objects such as upper and lower teeth are frequently appearing/disappearing during the animation. The mouth painting model is depicted in FIG. 5. The mouth internal vertices are divided into two parts: the teeth and the inner mouth. For the teeth and gum parameters, the deltas and colors are estimated with the visible teeth part. On the other hand, the tongue and palate colors can be estimated with the visible inner mouth part. The mouth parameters are as follows:
Upper Teeth Deltas (per frame) as referenced as 515: The positional offset from the upper polynomial curve 510
Lower Teeth Deltas (per frame) referenced as 525: The positional offset from the lower polynomial curve 520
Upper Teeth (per tooth): The colors of upper teeth 540 with radius
Lower Teeth (per tooth): The colors of lower teeth 550 with radius
Gum: The color of gum 530
Tongue: The color of tongue 560 (lower side of inner mouth vertices)
Palate: The color of palate 560 (upper side of inner mouth vertices).

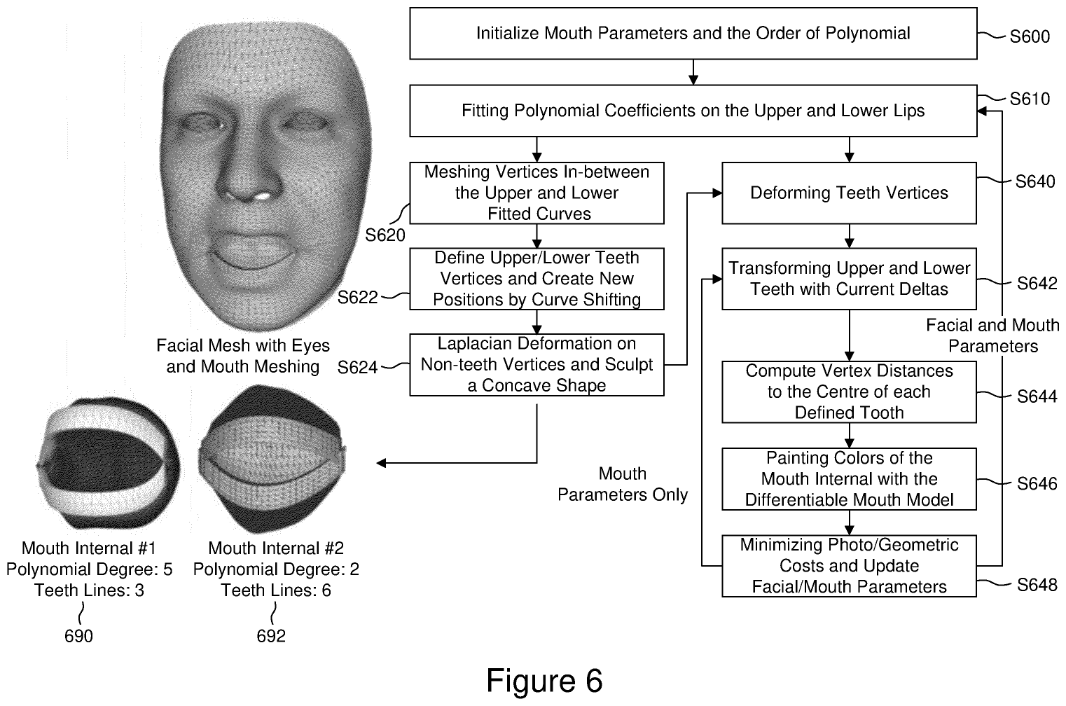

This simplified mouth internal shape is constructed from the upper 510/lower 520 polynomial curves fitted on the mouth lips. After the initial meshing process like the eye internals, the mouth shape becomes further deformed with curve shifting and the vertices representing the upper and lower teeth lines are defined. The shape of mouth internal is controllable by one or more of the order of polynomial, the coefficients offset, and the number of teeth lines. The detail of mouth meshing pipeline is illustrated in FIG. 6.

FIG. 6 is comparable to FIG. 4. In FIG. 6, in Step 600 or S600, there is a determination that a polynomial calculation is to be determined on the cutout portions for the mouth. Mouth parameters and the order of the polynomial can be initialized. This includes in S610 the fitting polynomial coefficients on the upper and lower portions, here the mouth instead of the eyelids. Then in S620 to S624, the internal meshing here of the mouth is performed that includes meshing vertices in-between the upper and lower curves S620, defining the upper/lower teeth vertices and creating new positions by curve shifting S622 and deforming vertices in S624 by Laplacian deformation. The Laplacian deformation is applied to concave the middle vertices toward the inside of the mouth. The upper and the lower teeth parts are later transformed by a delta vector to express the appearance and the disappearance of the teeth behind the lips. The creation of these polynomials is shown in FIG. 6 on the side by way of example for determination of mouth internal #1 (690) and Mouth internal #2 (692). In addition, following steps are then shown in steps S640 to S650 where the determination of mouth parameters is performed. This is shown in S640 to S650 which includes deforming teeth vertices S640, transforming upper and lower teeth with current deltas S642, computing vertex distances in S644, painting colors in S646 and minimizing the photo and geometric costs in S648.

The examples provided in FIGS. 3 to 6 are similar and provide understanding for an internal model that combines parameters (facial parameters) to provide better facial identity and accuracy. The parameters can include head transformation, expression, reflectance, illumination and so on. The internals painting losses need to be added as additional terms for approximating the eyes and mouth area. In addition, with information on the input image sequence, such as the eyelids and lips curves on the image space, or the high definition gaze dataset, the internal meshing models can define other minimization terms for improving facial reconstructions. The models as provided in these embodiments, give the possibilities of applying new measures for both gradient decent based and the deep based 3D facial reconstruction approaches. Moreover, this approach requires only a minimum preparation cost, as the minimum input is just a monocular RGB video.

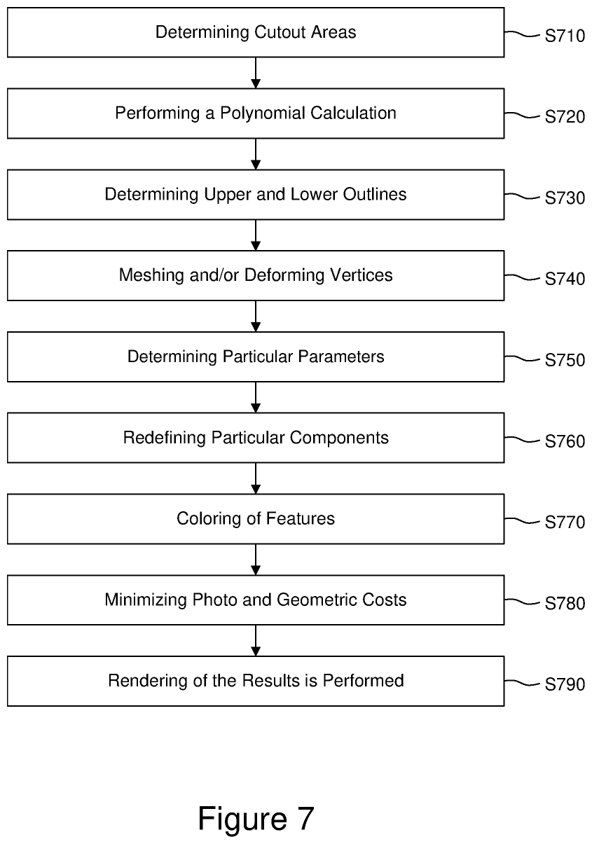

FIGS. 4 and 6 provide some examples of specifics of this so that for example a facial modeling pipeline can be provided. In one embodiment, the cutout/cutoff areas such as of a previous model is filled by using polynomial curves fitted into such areas as the upper and lower outlines of each hole, either the mouth or the eyes. The cutoff areas are further defined with areas to be removed and will be filled as shown in FIGS. 6 and 7 by intermediate fillers which in FIGS. 6 and 7 are more precisely referenced as deformity or meshing components as examples for ease of understanding. It is appreciated by those skilled in the art that other components can be used alternatively. The differentiable curves are defined by the fitting coefficients are then used for computing certain estimating parameters such as for example colors by computing them and allowing them to be added to the created model. In one embodiment, the meshed and painted models are then combined as parts of the entire face and improve the result of the traditional facial animation reconstruction, either in gradient-decent-based or in deep-based approaches through the inverse rendering process. This is shown in FIG. 7.

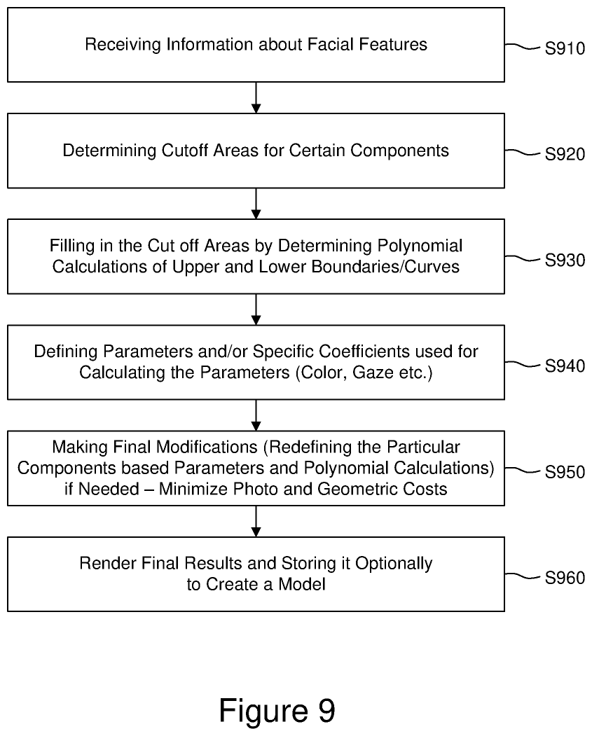

In FIG. 7, the method as shown provides a modeling pipeline by determining cutout areas S710 from a previous model, performing a polynomial calculation of the cutout areas or portions is then performed in S720. This is done in one embodiment by filling in the areas by: 1) determining upper and lower outlines of the cutoff portions using calculated polynomial curves and their coefficients S730; 2) meshing and/or deforming vertices in between the upper and lower curves S740; 3) determining particular parameters such as color and/or gaze or teeth positions S750; 4) redefining particular components by shifting curves or vertices and calculating some distances including vertex distances in S760. This can include applying Laplacian deformation tor transformation using delta vectors to express appearance and disappearance of certain features like teeth or iris etc. and 5) coloring of features in S770 and 6) minimizing photo and geometric costs in S780 via inverse rendering. Finally, a rendering of the results is performed in S790 which can optionally be stored when appropriate as a model or a new model (not shown). This is summarized in the flowchart illustration of FIG. 9.

In FIG. 9 a device or a method having or using at least a processor can be provided that can work towards retrieving and building a model that can be used for facial recognition. This will include in S910 of retrieving information about facial features of a person through an image or other means for example. In one embodiment, the image itself can be used like a feature. The inverse rendering compares the estimating facial mesh with this image itself. In S920 the areas to be removed, also referenced as cutoff areas or missing areas, can be determined from a previous model by the processor or determined accordingly if no previous model is in existence. In S930 the processor will then start filling in the cutoff areas by calculating polynomials for the upper and lower boundaries of those areas. Then certain parameters or coefficients of the areas are determined in S940. These are specific to the certain area so for eyes a gaze or color of iris is determined but for a mouth this may include color or location of teeth. A rendering in S950 is made then based on the determination of the polynomial boundaries and determined features that include parameters and coefficients. This final rendering is provided and optionally stored to generate a model in S960. This can be stored in a location, in one embodiment, where other renderings of a person or a body part is also stored and can then be used to develop a model for the feature or the person to develop facial recognition that is specific to the person, a particular place or demographics.

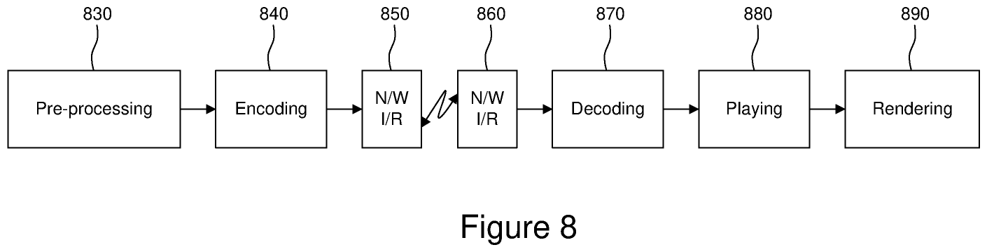

FIG. 8 schematically illustrates a general overview of an encoding and decoding system according to one or more embodiments. The system of FIG. 8 is configured to perform one or more functions and can have a pre-processing module 830 to prepare a received content (including one more images or videos) for encoding by an encoding device 840. The pre-processing module 830 may perform multi-image acquisition, merging of the acquired multiple images in a common space and the like, acquiring of an omnidirectional video in a particular format and other functions to allow preparation of a format more suitable for encoding. Another implementation might combine the multiple images into a common space having a point cloud representation. Encoding device 840 packages the content in a form suitable for transmission and/or storage for recovery by a compatible decoding device 870. In general, though not strictly required, the encoding device 840 provides a degree of compression, allowing the common space to be represented more efficiently (i.e., using less memory for storage and/or less bandwidth required for transmission. After being encoded, the data, is sent to a network interface 850, which may be typically implemented in any network interface, for instance present in a gateway. The data can be then transmitted through a communication network 850, such as the internet. Various other network types and components (e.g. wired networks, wireless networks, mobile cellular networks, broadband networks, local area networks, wide area networks, WiFi networks, and/or the like) may be used for such transmission, and any other communication network may be foreseen. Then the data may be received via network interface 860 which may be implemented in a gateway, in an access point, in the receiver of an end user device, or in any device comprising communication receiving capabilities. After reception, the data are sent to a decoding device 870. Decoded data are then processed by the device 880 that can be also in communication with sensors or users input data. The decoder 870 and the device 880 may be integrated in a single device (e.g., a smartphone, a game console, a STB, a tablet, a computer, etc.). In another embodiment, a rendering device 890 may also be incorporated.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed.

Accordingly, these and other implementations are contemplated by this application.

1. A method comprising;
receiving a two-dimensional image of a face and replacing one or more missing areas of the two-dimensional image by an intermediate filler to provide a three-dimensional facial model;
obtaining a plurality of representations for upper and lower boundaries of one or more of the intermediate filler areas; and
providing an inversible rendering of said face by modifying said intermediate fillers based on said obtained representations.

2. An apparatus comprising:
at least one processor configured to receive a two-dimensional image of a face and replace one or more missing areas by at least one intermediate filler to provide a three-dimensional facial model;
obtain a plurality of representations for upper and lower boundaries of one or more of the intermediate filler areas; and
provide an inversible rendering of said face by modifying said intermediate filler(s) based on said obtained representations.

3. The method of claim 1 comprising determining differentiable parameters and coefficients pertaining to said selected intermediate filler areas; and wherein modifying the intermediate fillers for said inverse rendering based on said obtained representations is provided by analyzing said differentiable parameters and coefficients.

4. The method of claim 1, wherein said three-dimensional facial model is created through an animation and said image is a video.

5. The method of a claim 1, wherein said three-dimensional facial model includes approximations of at least one eye and/or and mouth internals.

6. The method of claim 1, wherein said inversible rendering and said three-dimensional facial models are stored.

7. The method of claim 6, wherein said stored three-dimensional facial model and/or inversible rendering is used for building new three-dimensional facial models when another two dimensional image is received.

8. The method of claim 1, wherein obtaining a plurality of representations includes calculating said representations for upper and lower boundaries.

9. The method of claim 8, wherein said facial internals are approximated to at least one upper and lower representation boundary.

10. The method of claim 9, wherein intermediate fillers are provided by meshing components.

11-16. (canceled)

17. The method of claim 3, wherein said differentiable parameters is color, gaze and/or teeth positions.

18. (canceled)

19. The apparatus of claim 2, configured for determining differentiable parameters and coefficients pertaining to said selected intermediate filler areas; and wherein modifying the intermediate fillers for said inverse rendering based on said obtained representations is provided by analyzing said differentiable parameters and coefficients.

20. The apparatus of claim 2, wherein said three-dimensional facial model is created through an animation and said image is a video.

21. The apparatus of claim 2, wherein said three-dimensional facial model includes approximations of at least one eye and/or and mouth internals.

22. The apparatus of claim 2, wherein said inversible rendering and said three-dimensional facial models are stored.

23. The apparatus of claim 20, wherein said stored three-dimensional facial model and/or inversible rendering is used for building new three-dimensional facial models when another two dimensional image is received.

24. The apparatus of claim 2, wherein obtaining a plurality of representations includes calculating said representations for upper and lower boundaries.

25. The apparatus of claim 24, wherein said facial internals are approximated to at least one upper and lower representation boundary.

26. The apparatus of claim 25, wherein intermediate fillers are provided by meshing components.

27. The apparatus of claim 2, wherein said differentiable parameters is color, gaze and/or teeth positions.
